(19) United States
(12) Patent Application Publication
(10) Pub. No.: US 2004/0245357 A1
(43) Pub. Date: Dec. 9, 2004

(54) Particle pulverizer

(76) Inventor: Yukihiko Karasawa, Saitama-shi (JP)

Correspondence Address: Muramatsu & Associates, Suite 225, 7700 Irvine Center Drive, Irvine, CA, 92618, US

(21) Appl. No.: 10/480,879

(22) PCT Filed: Jun. 13, 2002
(86) PCT No.: PCT/JP02/05889

(30) Foreign Application Priority Data
Jun. 18, 2001 (JP) 2001-182784

(51) Int. Cl. B02C 19/06

(52) U.S. Cl. 241/5; 241/39

(57) ABSTRACT

To provide a particle pulverizer capable of suppressing the wear of parts. The particle pulverizer comprises: two flow passages 8a, 8a positioned on an approximately same straight line and having outlets disposed so as to be close and opposed to each other; through-holes 9, 9 provided at any positions of passages and having diameters smaller than the diameters of the flow passages, wherein liquid jetted out of one through-hole 9 does not reach the other through-hole 9.

### TECHNICAL FIELD

The present invention relates to particle pulverizers producing ultrafine particle dispersed by repeating compression, decompression and collision to a slurry in which solid phases are mixed to liquid phases or a liquid in which oil is mixed to water or water is mixed to oil.

### BACKGROUND ART

A particle pulverizer performing dispersion, crushing, emulsification or the like through cross collision is disclosed in Japanese Patent Publication [Unexamined] No. Heisei 6-47264 (47264/1994). In this particle pulverizer, in a high-pressure container, a plate-shaped body of which through-hole is sufficiently smaller than a passage for fluid in the high-pressure container is accommodated, and at the central portion of the through-hole of the plate-shaped body is provided an outlet perpendicularly connected to the through-hole. A fluid subjected to dispersion, crushing and emulsification is pressurized and is injected into the pressure container. The fluid flows into the passage in the container. The fluids pass the through-hole and collide with each other at the central portion of the plate-shaped body to perform dispersion, crushing and emulsification. The through-hole stated above is a nozzle or an orifice.

In this device, the distance between the through-holes that oppose to each other is short. Due to spreadings and uncontrolled directions of the fluids jetted out of the through-holes, it is difficult to cause the fluids to accurately collide head-on with each other. When the distance between the through-holes is short, fluid from one through-hole without collision collides with the other through-hole, which damages the other through-hole, so that the life of the device is shortened.

To prevent the above phenomenon, an invention according to Japanese Patent Publication [Unexamined] No. Heisei 10-337457 (337457/1998) is proposed. FIG. 3 is a cross-sectional view of a jet collider of Japanese Patent Publication [Unexamined] No. Heisei 10-337457. In this jet collider, the directions that high-pressure fluids jetted out of a first nozzle 31 and a second nozzle 32 are determined such that the loci of the high-pressure fluids cross with each other at prescribed angle at a point 34 in a chamber 33. With the angle between the loci, the fluid without collision does not damage the opposing nozzle.

### PROBLEMS TO BE SOLVED BY THE INVENTION

However, in the above-mentioned jet collider, the angle between the loci causes destructive power at a collision to be decreased. In this jet collider, it is necessary to completely collide fluids jetted out of the nozzles 31, 32 with each other at one point 34 in the chamber 33, so that the adjustment of the nozzles 31, 32 is difficult, and a long time and high level of trained skill are required, resulting in high cost at the replacement of the parts. Further, when the nozzles are clogged, usually, inverse pressure is applied to the nozzles. However, the measure is difficult to be taken because of large volume of the chamber 33.

In the inventions according to Japanese Patent Publication [Unexamined] Nos. Heisei 6-47264 (47264/1994) and Heisei 10-337457 (337457/1998), destructive force is applied to particles only once at a collision out of the nozzles. One collision cannot produce particles with desired size, so that the same operation is repeatedly performed in most devices. As a result, the quantity actually dealt with in a unit time becomes less than the capacity of the device.

The present invention has been made in consideration of the above facts, and the object thereof is to provide a particle pulverizer capable of suppressing the wear of parts.

In addition, another object of the present invention is to provide a particle pulverizer capable of applying plurality of destructive forces to particles through one operation.

### DISCLOSER OF INVENTION

To achieve the above object, a particle pulverizer according to the present invention comprises: two flow passages positioned on an approximately same straight line and having outlets disposed so as to be close and opposed to each other; through-holes provided at any positions of passages and having diameters smaller than the diameters of the flow passages, wherein liquid jetted out of one through-hole does not reach the other through-hole.

Another particle pulverizer according to the present invention comprises: an inlet flow passage to which high-pressure fluid is introduced; two U-shaped flow passages divided from the inlet flow passage in opposite directions and having outlets disposed so as to be close and opposed to each other; and through-holes provided in a middle of the U-shaped flow passages and having diameters smaller than the diameters of the U-shaped flow passages, wherein fluids jetted out of the outlets of the U-shaped flow passages collide with each other in the middle of the U-shaped flow passages, and the through-holes are disposed such that fluid jetted out of one through-hole does not reach the other through-hole.

Further, in the above particle pulverizers, a distance between the through-holes and a middle of the outlets may coincide with a second peak of collision energy of the fluids jetted out of the through-holes; more than one through-hole can be disposed in the flow passage; the diameters of the more than one through-hole can become smaller as the through-holes approach the outlet of the flow passage; and plurality of particle pulverizers described above may be connected with each other.

### BRIEF DESCRIPTION OF THE DRAWINGS

FIG. 1 is a cross-sectional view of a particle pulverizer according to the present invention; FIG. 2 shows two particle pulverizers connected with each other; and FIG. 3 is a conventional device for performing dispersion, crushing and emulsification.

### BEST MODE FOR CARRING OUT THE INVENTION

Next, embodiments of the present invention will be explained with reference to drawings.

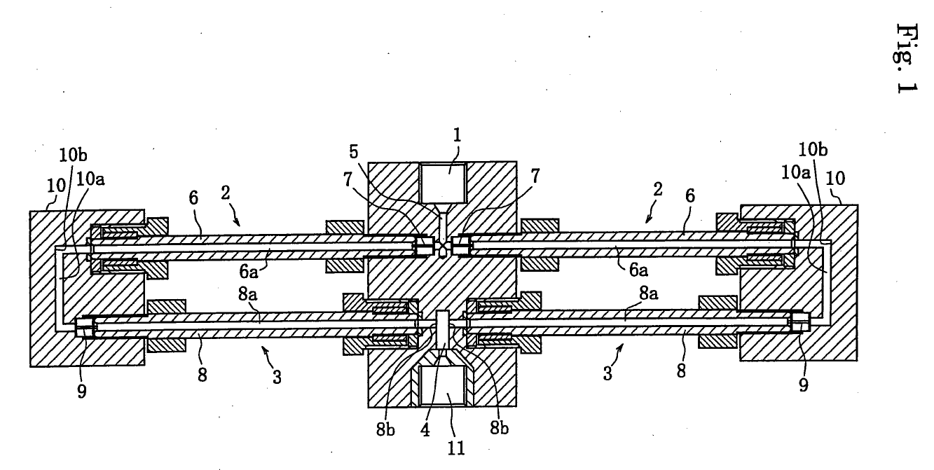

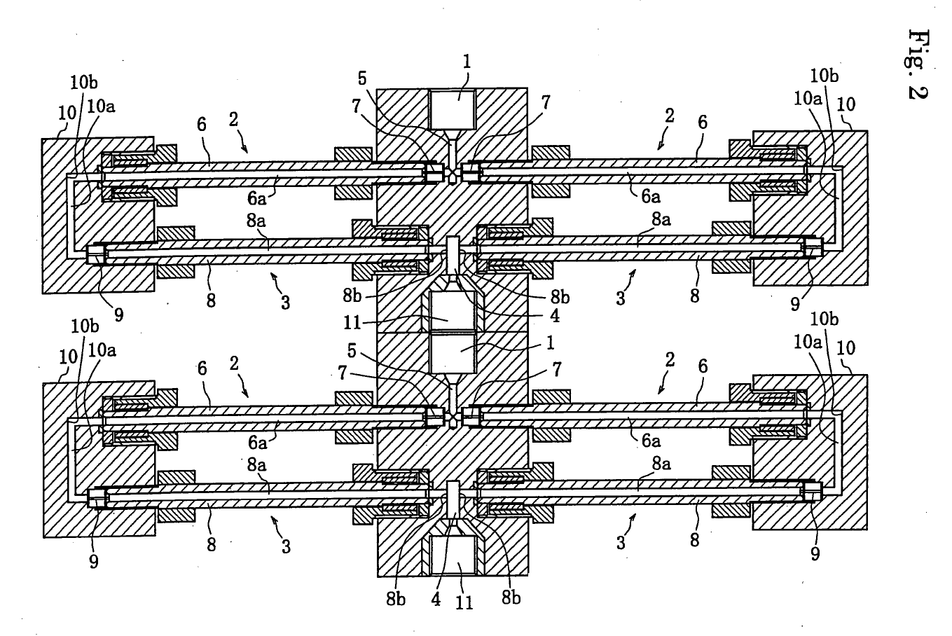

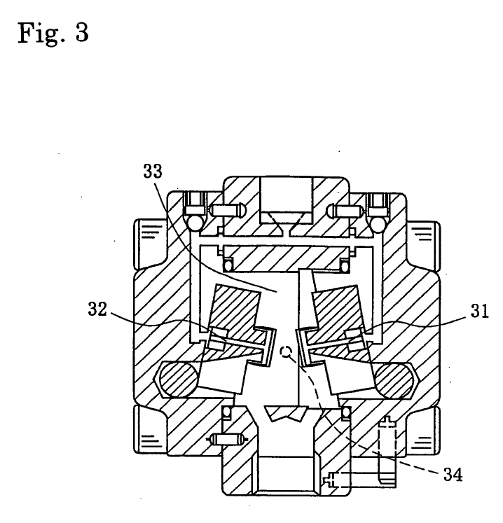

FIG. 1 is a cross-sectional view of a particle pulverizer according to the present invention. The device is provided with preliminary pulverizing sections 2 and a pulverizing section 3,4 right and left symmetrically about a feed spout 1.

The feed spout 1 is formed to be a cylindrical vessel. A hole is drilled at the central portion of the bottom face of the feed spout 1. The diameter of the hole is approximately half of that of the feed spout 1. An end of the hole is formed like a funnel, and the hole is connected to a passage 5. The passage 5 is divided right and left immediately, and divided portions are connected to the preliminary pulverization sections 2 that are symmetrically disposed right and left.

The preliminary particle section 2 comprises a cylindrical body 6 and a through-hole 7. An end of the cylindrical body 6 on the feed spout 1 side is provided with the through-hole 7, and to the other end of the cylindrical body 6 is mounted a tube fitting. The through-hole 7 is a nozzle or an orifice of which hole is smaller than diameters of the passages 5, 6a.

The pulverization section 3 comprises a cylindrical portion 8 and a through-hole 9. To an end of the cylindrical portion 8 on the pulverizing section 4 (as a discharge spout) side is attached a tube fitting, and to the other end is drilled the through-hole 9. A portion of the cylindrical body 6 on the tube fitting side and the through-hole 9 are communicated with each other through a communicating portion 10. The communicating portion 10 is formed to be a rectangular parallelepiped, and in the communicating portion 10 is formed a U-shaped flow passage 10a. Flow passages 6a, 8a of the cylindrical portions 6, 8 and a flow passage 10a constitutes a U-shaped flow passage.

A washer is attached to a portion where fittings of the cylindrical body 6, 8 are connected, and pressing the fittings prevents the inner fluid from leaking, that is, the portion is sealed. As the tube fitting, a conventional one with a tapered face for sealing may be used. But, it is preferable to use a fitting proposed in Japanese Patent Application No. 2001-168292, since the lives of the cylindrical bodies 6, 8 are considerably prolonged, and attaching and detaching the fitting can easily be carried out.

The through-holes 9, 9 right and left are disposed so as to oppose to each other. In the middle of the through-holes 9, 9 outlets 8b, 8b of the U-shaped flow passage are situated. Between the outlets 8b, 8b is positioned the pulverizing section 4.

Next, the dispersion, crushing and emulsification processes using the above particle pulverizer will be explained.

A mixed fluid such as slurry in which solid phases are mixed to liquid phases or liquid in which oil or water is mixed to water or oil is introduced to the feed spout 1 with the fluid being pressurized by a high-pressure pump. The pressure applied here is maintained until the pulverizing process such as dispersion, crushing and emulsification is completed. Condensed bodies (particles) in the mixed fluid have slight concaved portions or openings, and gas phases such as air exist in the openings. Applying pressure to the mixed phase causes the phases to be pressurized, and the volume of the gas phases is reduced. In addition, to the reduced portions enter liquid phases.

Passing the through-holes 7, 7, the fluid introduced to the feed spout 1 by the high-pressure pump is accelerated to a ultrahigh speed instantly, that is, the fluid instantly depressurized at the same time. Due to the depression, gas phases pressurized in the condensed bodies (particles) tend to expand. However, since liquid phases are filled over the gas phases, the gas phases cannot return to an original volume unless the liquid phases are removed. In comparison to gas phase, liquid phase has considerably smaller diffusion coefficient and higher viscosity, the liquid phases are not discharged first. Even under this condition, the gas phases tend to expand, so that the weakest portion of the condensed body is pulverized.

As described above, the first step of the particle pulverizing process of the condensed body is carried out.

While passing through the through-holes 7, 7, the fluid temporarily accelerated to a ultrahigh speed, but immediately after the passing, the speed of the fluid is reduced to an original speed. At this moment, the pressure decreased is returned to an original pressure. Then, gas phases entering insides of condensed bodies that remain without being pulverized in the previous process or concaved portions that are pulverized and newly exposed are compressed again, and liquid phases enter portions of which volume is reduced. This process completes instantly.

After that, passing through the through-holes 9, 9, the fluid is accelerated to a ultrahigh speed, and destructive action by the second compression and depression pulverizes the condensed bodies. Further, the fluids collide with each other at the pulverizing section 4 in the middle of the through-holes 9, 9. Portions where condensed force is weakened are destructed through energy generated by the collision. A part of the condensed bodies is not subjected to collision. However, since such bodies are pushed back by pressure before reaching the through-hole 9 on the opposite side, which does not damage the through-hole 9.

It is known that the energy of the collision has the first peak immediately after the fluid is jetted out of a nozzle, and the second peak exists at a position apart from the first peak. The through-holes 9, 9 are constructed such that the pulverizing section 4 is positioned at a position that is to be the second peak. The position of the second peak changes with pressure, density of the fluid and so on. Plurality kinds of cylindrical portions 8, 8 with different lengths are prepared, and a suitable one can be selected in accordance with fluid subjected to dispersion, crushing and emulsification.

The peaks of the energy are generated when the fluids pass through the through-holes 7, 7 also. Plurality kinds of cylindrical bodies 6, 6 with different lengths are also prepared to place the second peak to the surface of a wall 10b. This prevents particles, which are pulverized by the destructive action of the compression and depression, from condensing again.

FIG. 2 shows two particle pulverizers connected with each other. To the pulverizing section 4 of one particle pulverizer is connected to the feed spout 1 of the other particle pulverizer to successively perform the above processes. In the FIG. 2, two particle pulverizers are connected, but, more than two particle pulverizers can be connected in accordance with the particle size, hardness of the particles and so on. When particle size does not reach a desired value through a single process, the fluids are continuously processed without being exposed to air with the system in which plurality of particle pulverizers are connected with each other, which realizes dispersion, crushing and emulsification with considerably high efficiency.

In addition, as another method, it is possible to adopt a construction to which a through-hole is added besides the through-holes 7, 9. Every time the fluids pass the through-holes, particle size becomes smaller and smaller due to destructive action by compression and depression.

At the dispersion, crushing and emulsification, a large condensed body in the fluid may clog the through-holes 7, 9. In such a case, the outlet spout 11 and the feed spout 1 are mounted in a reverse way, and fluid pressurized by a high-pressure pump is introduced into the outlet spout 11 to easily eliminate the clogging.

In order to efficiently destruct the condensed bodied, which are not destructed or insufficiently destructed even passing through the through-holes 7, 7, at the next through-holes 9, 9, larger force is preferably added. For this purpose, the diameters of the through-holes 9, 9 may be smaller than those of the through-holes 7. Due to the smaller diameter, the velocity of the fluid increases, and degree of depressurization is increased, which strengthens the destructive action by compression and depression. In addition, gradually decreasing the sizes of the through-holes also functions to prevent clogging.

### Industrial Applicability

As described above, with the particle pulverizer according to the present invention comprising: two flow passages positioned on an approximately same straight line and having outlets disposed so as to be close and opposed to each other; through-holes provided at any positions of passages and having diameters smaller than the diameters of the flow passages, wherein liquid jetted out of one through-hole does not reach the other through-hole, the wear of parts of the particle pulverizer can be suppressed.

In the above particle pulverizer, more than one through-hole can be disposed in the flow passage, or a distance between the through-holes and a middle of the outlets may coincide with a second peak of collision energy of the fluids jetted out of the through-holes, which securely perform repeated pulverizations.

The diameters of more than one through-hole can become smaller as the through-holes approach the outlet of the flow passage, which strengthens the destructive action by compression and depression in stages. As a result, the efficiency of the pulverization is increased, and clogging is suppressed.

Plurality of particle pulverizers described above can be connected with each other, which realizes dispersion, crushing and emulsification with remarkably high efficiency.

1. A particle pulverizer comprising:
two flow passages positioned on an approximately same straight line and having outlets disposed so as to be close and opposed to each other;
through-holes provided at any positions of said passages and having diameters smaller than the diameters of the flow passages,
wherein liquid jetted out of one through-hole does not reach the other through-hole.

2. A particle pulverizer comprising:
an inlet flow passage to which high-pressure fluid is introduced;
two U-shaped flow passages divided from said inlet flow passage in opposite directions and having outlets disposed so as to be close and opposed to each other; and
through-holes provided in a middle of said U-shaped flow passages and having diameters smaller than the diameters of the U-shaped flow passages,
wherein fluids jetted out of the outlets of the U-shaped flow passages collide with each other, and said through-holes are disposed such that fluid jetted out of one through-hole does not reach the other through-hole.

3. The particle pulverizer as claimed in claim 1 or 2, wherein a distance between said through-holds and a middle of said outlets coincides with a second peak of collision energy of said fluids jetted out of the through-holes.

4. The particle pulverizer as claimed in claim 1, 2 or 3, wherein more than one through-hole is disposed in said flow passage.

5. The particle pulverizer as claimed in claim 4, wherein diameters of said more than one through-hole become smaller as the through-holes approach said outlet of the flow passage.

6. A particle pulverizer having plurality of said particle pulverizers claimed in one of claims 2 to 5.
